(19) United States
(12) Patent Application Publication
(10) Pub. No.: US 2016/0350814 A1
(43) Pub. Date: Dec. 1, 2016

(54) SYSTEMS, METHODS, AND APPARATUS FOR BUDGET ALLOCATION

(71) Applicant: Turn Inc., Redwood City, CA (US)

(72) Inventors: Sahin Cem Geyik, Redwood City, CA (US); Abhishek Saxena, Cupertino, CA (US); Ali Dasdan, San Jose, CA (US)

(73) Assignee: Turn Inc., Redwood City, CA (US)

(21) Appl. No.: 15/232,660

(22) Filed: Aug. 9, 2016

Related U.S. Application Data
(63) Continuation of application No. 14/259,045, filed on Apr. 22, 2014, now abandoned.
(60) Provisional application No. 61/938,979, filed on Feb. 12, 2014.

(51) Int. Cl. G06Q 30/02; G06F 17/30

(52) U.S. Cl. CPC G06Q 30/0275; G06Q 30/0249; G06Q 30/0243; G06F 17/30194

(57) ABSTRACT

Systems, methods, and apparatus are disclosed herein. Systems include a plurality of mappers configured to extract a plurality of sequences from user data. The plurality of sequences includes sequential representations of data events associated with a user and a sub-campaign. The plurality of sequences may identify a sequence of data events having action identifiers corresponding to user actions. Systems also include a plurality of reducers configured to generate, for each sub-campaign, a first set of aggregated numbers identifying sequences including action identifiers, and further configured to generate, for each sub-campaign, a second set of aggregated numbers of sequences not including action identifiers. Systems further include a plurality of servers configured to generate a plurality of probabilistic weights. The plurality of servers is further configured to generate a plurality of performance metrics based on the plurality of probabilistic weights.

### CROSS-REFERENCE TO RELATED APPLICATIONS

This application is a continuation of U.S. patent application Ser. No. 14/259,045, filed on Apr. 22, 2014 which claims the benefit under 35 U.S.C. §119(e) of U.S. Provisional Patent Application No. 61/938,979, filed on Feb. 12, 2014 which are incorporated herein by reference in their entirety for all purposes.

### TECHNICAL FIELD

This disclosure generally relates to online advertising, and more specifically to allocating a budget for online advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Systems, methods, and apparatus, are disclosed herein. Systems may include a plurality of mappers configured to extract a plurality of sequences from user data. The plurality of sequences includes sequential representations of data events associated with a user and a sub-campaign of a plurality of sub-campaigns. At least some of the plurality of sequences identify a sequence of data events having at least one action identifier of a plurality of action identifiers corresponding to at least one of a plurality of user actions. Systems may also include a plurality of reducers configured to generate, for each sub-campaign, a first set of aggregated numbers identifying sequences including action identifiers, and further configured to generate, for each sub-campaign, a second set of aggregated numbers of sequences not including action identifiers. Systems may further include a plurality of servers configured to generate a plurality of probabilistic weights based on the generated plurality of sequences, the first set of aggregated numbers, and the second set of aggregated numbers. The plurality of servers is further configured to generate a plurality of performance metrics based on the plurality of probabilistic weights. Systems may also include a distributed file system configured to store the user data, the plurality of sequences, the plurality of probabilistic weights, and the plurality of performance metrics.

In some embodiments, the user data is partitioned and assigned to each of the plurality of mappers based on a plurality of user identifiers. In various embodiments, the plurality of mappers is further configured to extract a plurality of costs associated with data events included in the plurality of sequences. According to some embodiments, the plurality of mappers is further configured to determine a percentage of at least one user action of the plurality of user actions that is attributed to at least one sub-campaign of the plurality of sub-campaigns. In various embodiments, each probabilistic weight of the plurality of probabilistic weights identifies a probability of a sub-campaign being associated with an action identifier of the plurality of action identifiers. According to some embodiments, the plurality of probabilistic weights is normalized. In various embodiments, the plurality of reducers is configured to generate the first and second aggregated numbers based on a plurality of sub-campaign identifiers associated with the plurality of sequences.

According to some embodiments, the determining of the plurality of performance metrics further includes determining a value associated with each sub-campaign of the plurality of sub-campaigns, determining a total cost associated with each sub-campaign of the plurality of sub-campaigns, and determining a return-on-investment associated with each sub-campaign of the plurality of sub-campaigns based on the determined value and the determined total cost associated with each sub-campaign. In various embodiments, the plurality of servers is further configured to determine a plurality of allocated budgets based on the plurality of performance metrics, each allocated budget of the plurality of allocated budgets being determined for each sub-campaign of the plurality of sub-campaigns, and each allocated budget of the plurality of allocated budgets being a portion of a total budget associated with an advertisement campaign. In some embodiments, the plurality of servers is further configured to send a message to additional servers based on at least one of the plurality of allocated budgets, the message including a bid request for an advertisement. In particular embodiments, the distributed file system is a Hadoop distributed file system.

Also disclosed herein are systems that may include a distributed file system. The systems may also include one or more processors configured to extract a plurality of sequences from user data, where each of the plurality of sequences includes a sequential representation of data events associated with a user and a sub-campaign of a plurality of sub-campaigns, and where at least some of the plurality of sequences identify a sequence of data events having at least one action identifier of a plurality of action identifiers corresponding to at least one of a plurality of user actions. The one or more processors may be further configured to generate, for each sub-campaign, a first set of aggregated numbers identifying sequences including action identifiers, and generate, for each sub-campaign, a second set of aggregated numbers of sequences not including action identifiers. The systems may also include a plurality of servers configured to generate a plurality of probabilistic weights based on the generated plurality of sequences, the first set of aggregated numbers, and the second set of aggregated numbers, and where the plurality of servers is further configured to generate a plurality of performance metrics based on the plurality of probabilistic weights.

In some embodiments, the user data is partitioned and assigned to each of a plurality of mappers based on a plurality of user identifiers. In various embodiments, the one or more processors are further configured to extract a plurality of costs associated with data events included in the plurality of sequences, determine a percentage of at least one user action of the plurality of user actions that is attributed to at least one sub-campaign of the plurality of sub-campaigns, and generate the first and second aggregated numbers based on a plurality of sub-campaign identifiers associated with the plurality of sequences. In some embodiments, each probabilistic weight of the plurality of probabilistic weights identifies a probability of a sub-campaign being associated with an action identifier of the plurality of action identifiers. According to various embodiments, the distributed file system is a Hadoop distributed file system.

Also disclosed herein are methods that may include extracting, using a plurality of mappers, a plurality of sequences from user data, where each of the plurality of sequences includes a sequential representation of data events associated with a user and a sub-campaign of a plurality of sub-campaigns, and where at least some of the plurality of sequences identify a sequence of data events having at least one action identifier of a plurality of action identifiers corresponding to at least one of a plurality of user actions. The methods may further include generating, using a plurality of reducers, a first set of aggregated numbers identifying sequences including action identifiers. The methods may also include generating, using the plurality of reducers, a second set of aggregated numbers of sequences not including action identifiers. The methods may further include generating, using one or more processors, a plurality of probabilistic weights based on the generated plurality of sequences, the first set of aggregated numbers, and the second set of aggregated numbers. The methods may also include generating, using the one or more processors, a plurality of performance metrics based on the plurality of probabilistic weights.

In some embodiments, the user data is partitioned and assigned to each of the plurality of mappers based on a plurality of user identifiers. In various embodiments, the methods further include extracting, using the plurality of mappers, a plurality of costs associated with data events included in the plurality of sequences, determining, using the plurality of mappers, a percentage of at least one user action of the plurality of user actions that is attributed to at least one sub-campaign of the plurality of sub-campaigns, and generating, using the plurality of reducers, the first and second aggregated numbers based on a plurality of sub-campaign identifiers associated with the plurality of sequences. In various embodiments, each probabilistic weight of the plurality of probabilistic weights identifies a probability of a sub-campaign being associated with an action identifier of the plurality of action identifiers.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of an advertiser hierarchy, implemented in accordance with some embodiments.

FIG. 2 illustrates an example of a budget allocation, implemented in accordance with some embodiments.

FIG. 3A illustrates an example of action attribution, implemented in accordance with some embodiments.

FIG. 3B illustrates another example of action attribution, implemented in accordance with some embodiments.

FIG. 4 illustrates a flow chart of an example of a first portion of an action attribution method, implemented in accordance with some embodiments.

FIG. 5 illustrates a flow chart of an example of a second portion of an action attribution method, implemented in accordance with some embodiments.

FIG. 6 illustrates a flow chart of an example for determining a spending potential, implemented in accordance with some implementations.

FIG. 7 illustrates a flow chart of an example of a method that may be used to allocate a budget, implemented in accordance with some embodiments.

FIG. 8 illustrates an example of a data processing system which may be used to implement a first portion of an action attribution method in accordance with some embodiments.

FIG. 9 illustrates an example of a data processing system which may be used to implement a second portion of an action attribution method in accordance with some embodiments.

FIG. 10 illustrates an example of a data processing architecture that may be used to allocate a budget, implemented in accordance with some embodiments.

FIG. 11 illustrates a graph of an example of multi-touch attribution based allocation of a budget, implemented in accordance with some embodiments.

FIG. 12 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, it is preferable to provide the best ad for a given user in an online context. Advertisers often set constraints which affect the applicability of the advertisements. For example, an advertiser might want to target only users in a particular geographical area or region who may be visiting web pages of particular types for a specific campaign. As used herein, a campaign may be an advertisement strategy or campaign which may be implemented across one or more channels of communication. Furthermore, the objective of advertisers may be to receive as many user actions as possible by utilizing different campaigns in parallel. In some embodiments, actions or user actions may be advertiser defined and may include an affirmative act performed by a user, such as inquiring about or purchasing a product, filling out a form, and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid. Accordingly, each advertiser needs to carefully manage their budget to maximize their capability or potential to bid.

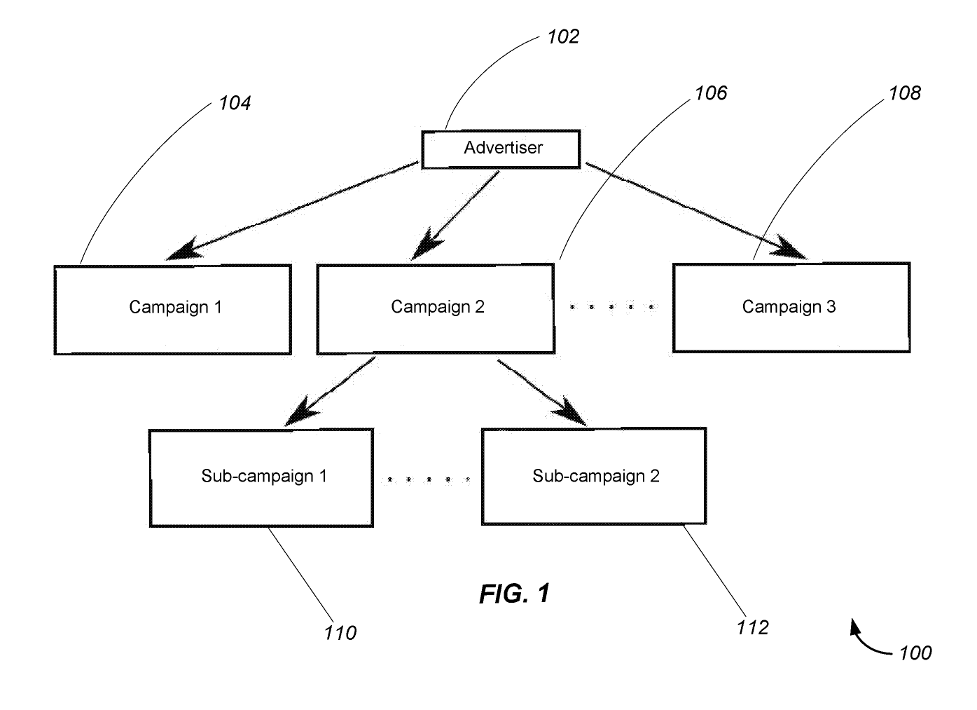

Various systems, methods, and apparatus disclosed herein effectively and efficiently distribute a campaign's budget among one or more components of a hierarchy associated with the campaign. For example, as discussed in greater detail below with reference to FIG. 1, a campaign may include several components which may each be a targeted or focused campaign, such as a sub-campaign or line item, both of which may be referred to herein interchangeably. In some embodiments, the sub-campaigns may have different targeting criteria and may be directed to different groups of users via different channels of communication. In various embodiments, a return-on-investment (ROI), which may be a value received compared to an amount spent on advertising, may vary among sub-campaigns because the sub-campaigns may have different performances and spending potentials due to their different targeting criteria. Various embodiments disclosed herein may maximize the ROI for each component of a campaign, which may include the sub-campaigns and line items. In this way, an overall budget allocated to a campaign may be distributed optimally across various sub-campaigns and line items included within the campaign.

Furthermore, as discussed in greater detail below, various systems, methods, and apparatus disclosed herein may utilize various action attribution techniques to accurately and efficiently determine a performance metric associated with each sub-campaign. For example, the systems, methods, and apparatus disclosed herein may determine which advertisements shown from which sub-campaign(s may have caused a user action to occur, and to what extent. Such a determination or attribution enables an accurate calculation of an ROI (or other performance metric) associated with each sub-campaign, as well as an optimal distribution of the overall budget.

FIG. 1 illustrates an example of an advertiser hierarchy, implemented in accordance with some embodiments. As previously discussed, in the context of online advertising, an advertiser, such as the advertiser 102, may display or provide an advertisement to a user via a publisher, which may be a web site, a mobile application, or other browser or application capable of displaying online advertisements. The advertiser 102 may attempt to achieve the highest number of user actions for a particular amount of money spent, thus maximizing the return on the amount of money spent. Accordingly, the advertiser 102 may create various different tactics or strategies to target different users. Such different tactics and/or strategies may be implemented as different advertisement campaigns, such as campaign 104, campaign 106, and campaign 108, and/or may be implemented within the same campaign. Each of the campaigns and their associated sub-campaigns may have different targeting rules. For example, a sports goods company may decide to set up a campaign, such as campaign 104, to show golf equipment advertisements to users above a certain age or income, while the advertiser may establish another campaign, such as campaign 106, to provide sneaker advertisements towards a wider audience having no age or income restrictions. Thus, advertisers may have different campaigns for different types of products. The campaigns may also be referred to herein as insertion orders.

As similarly discussed above, each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 110 may include one or more targeting rules that configure or direct the sub-campaign 110 towards an age group of 18-34 year old males that use a particular social media network, while the sub-campaign 112 may include one or more targeting rules that configure or direct the sub-campaign 112 towards female users of a particular mobile application. As similarly stated above, the sub-campaigns may also be referred to herein as line items.

Accordingly, an advertiser 102 may have multiple different advertisement campaigns associated with different products. Each of the campaigns may include multiple sub-campaigns or line items that may each have different targeting criteria. Moreover, as will be discussed in greater detail below, each campaign may have an associated budget which must be distributed amongst the sub-campaigns included within the campaign to provide users or targets with the advertising content.

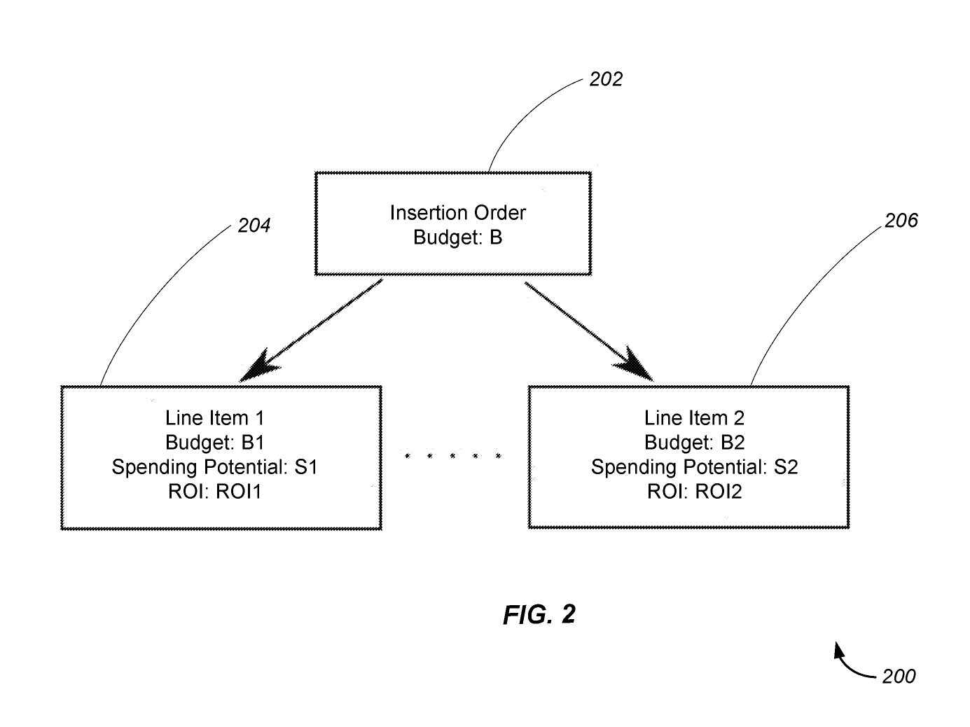

FIG. 2 illustrates an example of a budget allocation, implemented in accordance with sonic embodiments. As similarly discussed above, in the context of an advertisement campaign, budget allocation may refer to the distribution of a budget to the sub-campaigns or line items included within the campaign. Such an allocation may be performed daily as part of an insertion order, such as the insertion order 202. Accordingly, an insertion order 202 associated with a campaign may include one or more data values and/or rules identifying an allocation of a budget to sub-campaigns or line items within the campaign, such as a first line item 204 and second line item 206. An advertiser may configure insertion order level budgets manually, and may set budgets based on spending potentials of line items, which may be whether a line item's targeting allows it to reach enough users to be able to spend the money that is assigned to it, as well as performance metrics, which may refer to a value of user actions received based on an amount spent by a particular line item. For example, a performance metric may be a return-on-investment (ROI) provided by a sub-campaign or a line item.

As shown in FIG. 2, a campaign or insertion order may have a daily budget of B, and line items included within the campaign may be assigned daily budgets Bᵢ such that Σᵢ Bᵢ=B. Moreover, each line item may have an ROI of Rᵢ, and a maximum spending potential (as may be a consequence of targeting, bidding, etc.) of Sᵢ. Thus, a first line item 204 may have a budget of B₁, an ROI of R₁, and a maximum spending potential of S₁. Moreover, the second line item 206 may have a budget of B₂, an ROI of R₂, and a maximum spending potential of S₂. In this example, the campaign 200 may only include the first line item 204 and the second line item 206.

During budget allocation, a budget for a line item may be configured such that Bᵢ≦Sᵢ. In this way, no line item is assigned more money than it can spend. However, as may be the case with conventional budget allocation methods, values for spending potentials and ROIs of line items are often not available. Thus, conventional methods of budget allocation often require that an advertiser guess these values. Such guessing results in inaccurate and inefficient allocation of the budget among sub-campaigns and line items because such guessing is often wrong and results in over-allocation or under-allocation of budgets to line items or sub-campaigns. As previously discussed, line items and sub-campaigns may be referred to interchangeably. Therefore, while FIG. 2 makes reference to line items, the same may apply to sub-campaigns associated with a campaign.

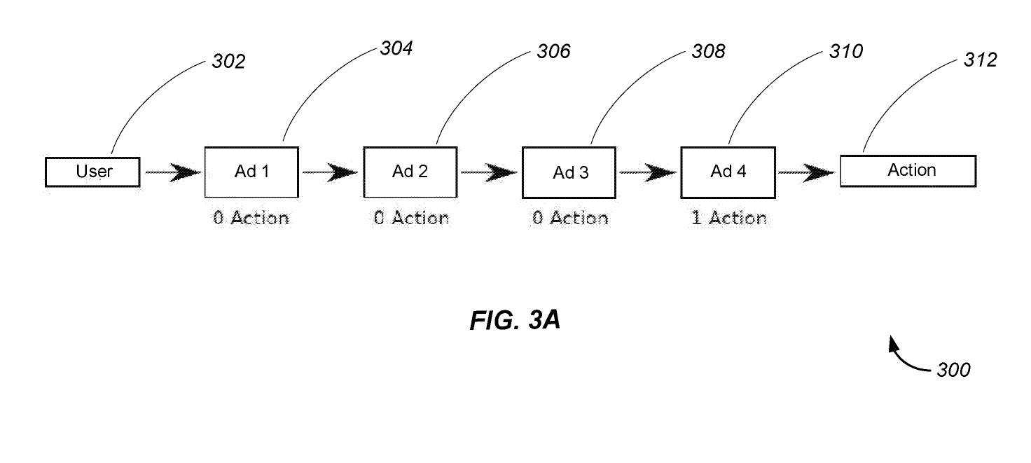

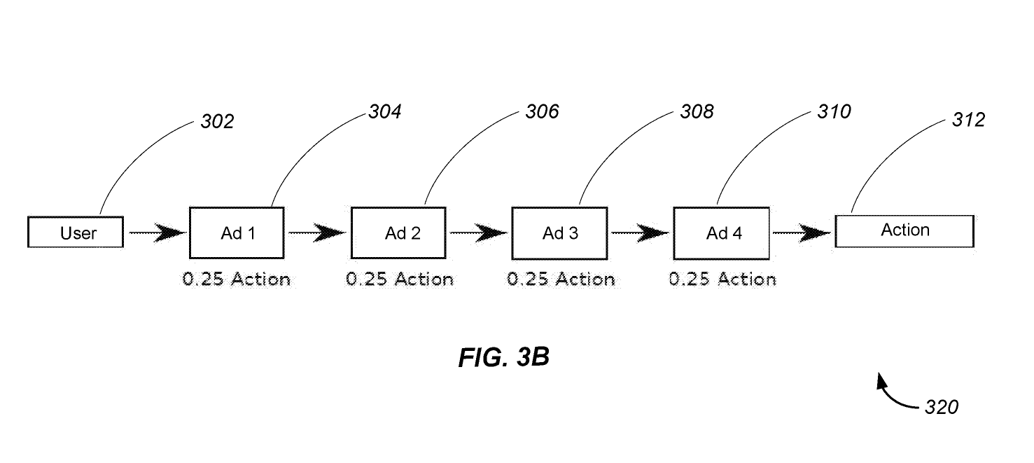

FIG. 3A illustrates an example of action attribution, implemented in accordance with some embodiments. As previously discussed, it may be desirable for an advertiser to receive as many user actions as possible. To effectively identify which sub-campaigns and line items are providing the greatest return, an advertiser may determine which sub-campaign contributed to how many user actions, hence quantifying the effectiveness of the different tactics utilized in each sub-campaign. As shown in FIG. 3A, an action or user action, which may be referred to herein interchangeably, may occur long after an advertisement is shown to a user, and there may be many intervening events. For example, a user 302 may see several advertisements online, such as a first advertisement 304, a second advertisement 306, a third advertisement 308, and a fourth advertisement 310. The user 302 may subsequently perform a user action 312, which may be the purchase of an item. In this example, it may be difficult to determine which advertisement caused the user action 312, and it may also be difficult to determine to what extent the user action 312 should be attributed to a particular advertisement. Accordingly, it may be difficult to attribute user actions to sub-campaigns and reliably determine what return the sub-campaign is providing.

As similarly discussed above, in order to correctly allocate a budget to sub-campaigns, it should be determined how effective each sub-campaign is. Accordingly, it may be desirable to determine how many user actions are attributed to each sub-campaign, as well as how much money was spent on each sub-campaign. The contribution of a sub-campaign may be calculated or determined based on an action attribution method. One example of a method of attributing a user action to a sub-campaign may be a last-touch attribution method in which the user action is fully attributed to the last event in a sequence of events leading up to the user action. As will be discussed in greater detail below, sequences of events may be constructed based on available data for each user action. As shown in FIG. 3A and discussed above, the user action 312 may be the purchase of an item, such as an online purchase of a wallet. The sequence of events leading to the user action 312 may include the sequential presentation of advertisements 304-310 the user 302. In some embodiments, a last-touch attribution method 300 may be implemented that attributes the user action 312 entirely (100 percent) to the last event in the sequence of events, which may be the last advertisement seen by the user. In the example shown in FIG. 3A, the last event was the display of fourth advertisement 310. Accordingly, the last-touch attribution method 300 may attribute the user action 312 entirely to the fourth advertisement 310, and such an attribution or association may be stored as one or more data values in a database system, as discussed in greater detail below.

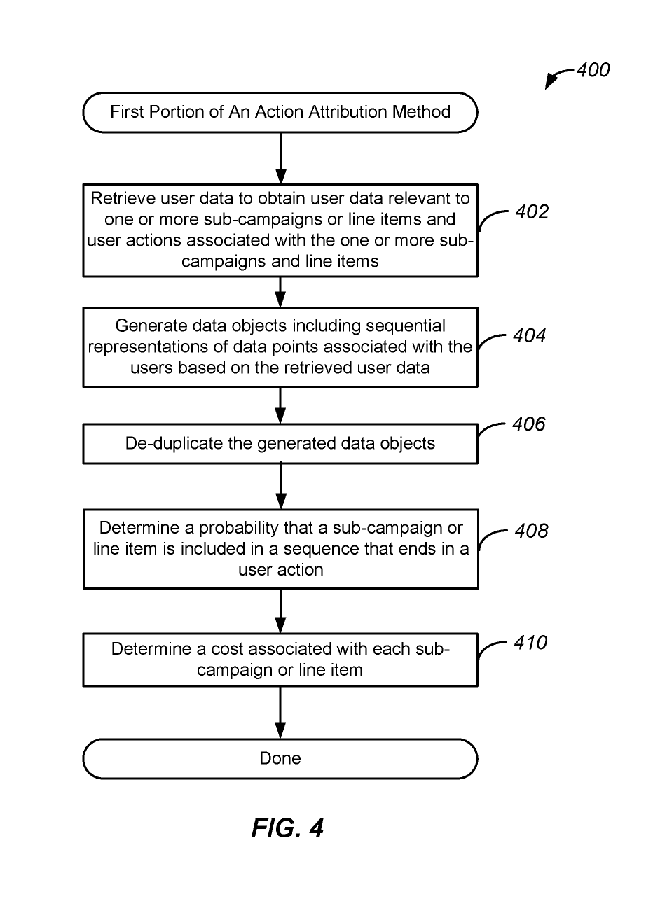

FIG. 3B illustrates another example of action attribution, implemented in accordance with alternative embodiments. In some embodiments, a multi-touch action attribution method 320 may implemented in which the user action is attributed to multiple events which may have occurred in a sequence leading up to a user action, such as a series of advertisements seen by a user prior to a purchase. Accordingly, the user action 312 may be attributed to some or all events within the sequence of events resulting in the user action instead of just the last event. For example, instead of entirely attributing the user action 312 to the fourth advertisement 310 in the sequence, the multi-touch action attribution method 320 may attribute a portion or percentage of the user action to each event in the sequence. Accordingly, the first advertisement 304 may be attributed 25% of the user action 312, the second advertisement 306 may be attributed 25% of the user action 312, the third advertisement 308 may be attributed 25% of the user action 312, and the fourth advertisement 310 may be attributed 25% of the user action 312. The sum of the partial attributions may add up to 100%. It will be appreciated that while the distribution of the attribution of the user action 312 has been described as being equally distributed among advertisements 304-310, the distribution might not be equal and might be weighted based on or more other performance metrics, such as an ROI value, discussed in greater detail below with reference to FIGS. 4, 5, 6, and 7.

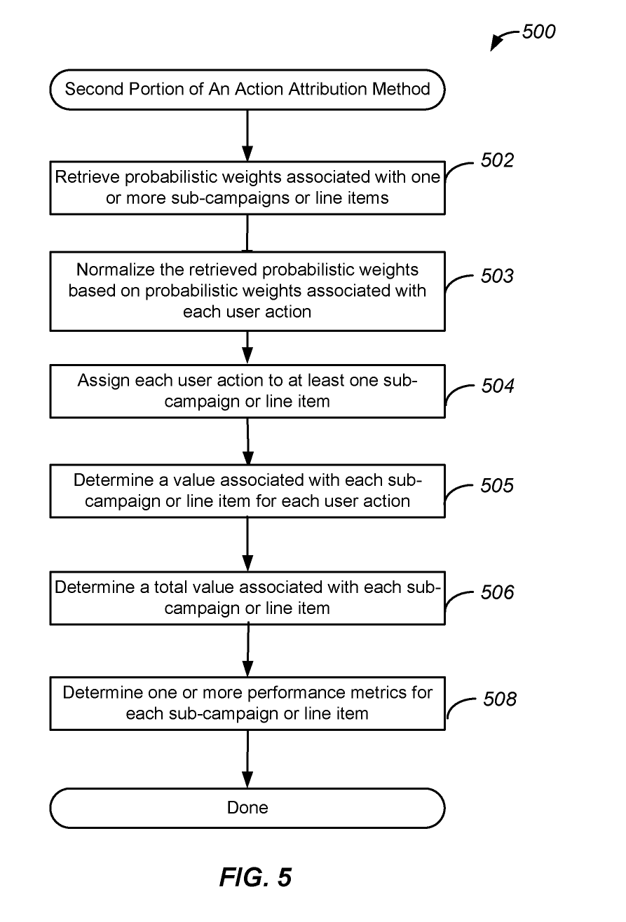

As will be appreciated, the methods and attribution numbers described with reference to FIG. 3A and FIG. 3B are merely examples and are in no way intended to limit the embodiments disclosed herein. Additional examples will be discussed in greater detail below with reference to FIGS. 4 and 5. As previously discussed, line items and sub-campaigns may be referred to interchangeably. Therefore, while FIGS. 3A and 3B make reference to sub-campaigns, the same may apply for line items associated with a campaign.

FIG. 4 illustrates a flow chart of an example of a first portion of an action attribution method, implemented in accordance with some embodiments. As similarly discussed above, action attribution methods may be used to accurately assess how many user actions or portions of user actions should be attributed to sub-campaigns or line items, and consequently how much return was derived from the investment in each sub-campaign or line item. In various embodiments, a return-on-investment (ROI) associated with a sub-campaign/line item may be determined based on equation 1 provided below:

$$R O {I}_{{l}_{i}} = \frac{{Σ}_{∀ {a}_{j} , p ( {l}_{i} \vert {a}_{j} ) > 0} p ( {l}_{i} \vert {a}_{j} ) v ( {a}_{j} )}{Money spent by {l}_{i}} \qquad ( 1 )$$

In equation 1, v(aⱼ) may be the monetary value that is received by user action aⱼ (which may be the profit that the advertiser earns by selling that specific product). Moreover, the term p(lᵢ|aⱼ) may represent an attribution component that determines a percentage of the user action aⱼ that is attributed to line item lᵢ. In some embodiments, for a last-touch-attribution methodology, p(lᵢ|aⱼ) may be a 0 or 1. Moreover, for a multi-touch attribution methodology, p(lᵢ|aⱼ) ∈ [0, 1] because there may be partial attribution of a single user action to many sub-campaigns. Thus, according to various embodiments, one or more action attribution methods may be performed to determine a value of the attribution component p(lᵢ|aⱼ) for each sub-campaign/line item. In various embodiments, the action attribution methods may include a first portion and a second portion. The first portion may be implemented to calculate the general importance of line-items via touch-points (which may be interactions or impressions between a line item or sub-campaign and a user) in the user data. The second portion may distribute user actions among line items based on their determined importance which may be identified by probabilistic weights, thus attributing the user actions to the line items and enabling a calculation of a return on investment. In some embodiments, the action attribution methods may be constrained based on one or more parameters. For example, the user data that is processed may be constrained to user data that was generated during a predetermined period of time prior to an event of interest. In this example, the user data may be restricted to events such as interactions and clicks that may have occurred less than seven days prior to a user action.

In various embodiments, the first portion of the action attribution method 400 may determine a relative importance of a sub-campaign or line item based on data points which may identify or represent touch points, points of contact, and/or interactions between the line item and the user. Such a data point may identify an interaction in which the user views an advertisement provided by a sub-campaign, clicks on an advertisement, fills out a form, or any other suitable interaction in which a line item or sub-campaign presents content to the user. As will be discussed in greater detail below, the data points associated with the users and line items may be used to determine a probability of how likely a line item is to be in a sequence of events leading to a desired user action which, as previously discussed, may be the purchase of a product or other action by a user. In various embodiments, the first portion of the action attribution method 400 may determine the probabilities and represent them as probabilistic weights for use by the second portion of the action attribution method 500 discussed in greater detail with reference to FIG. 5.

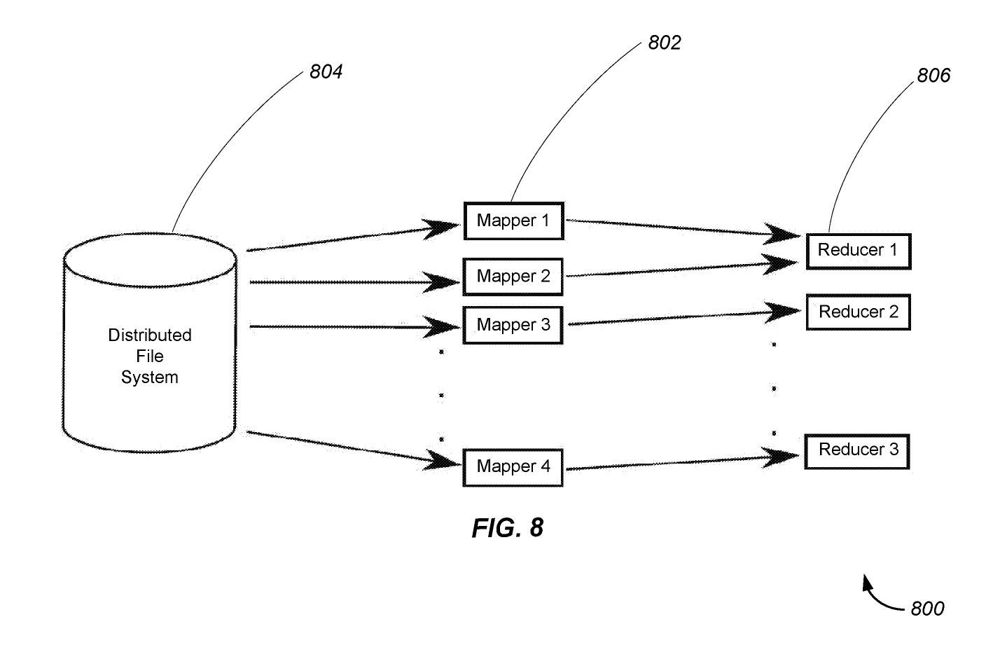

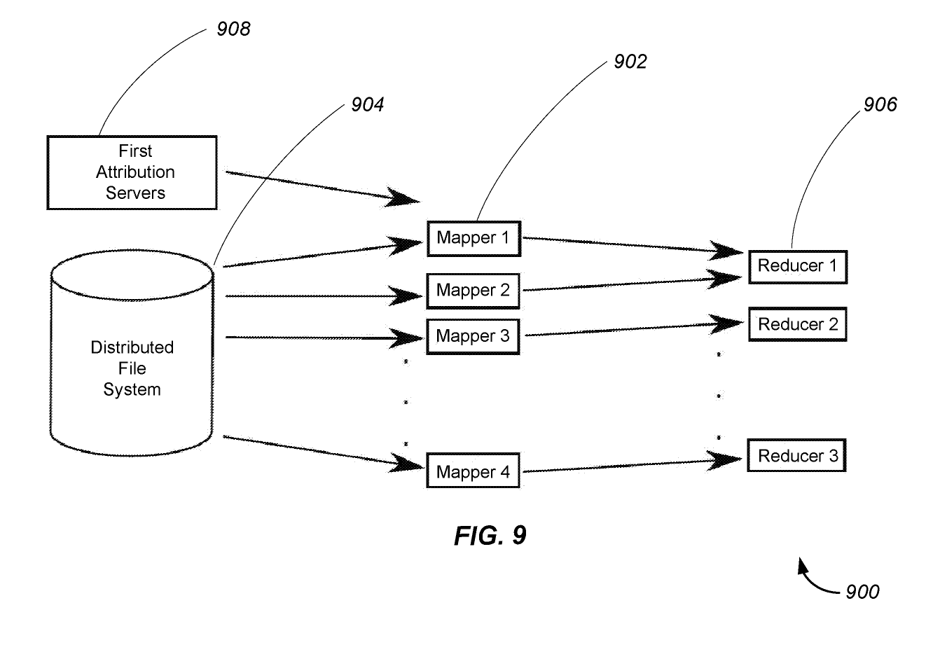

Accordingly, the first portion of the action attribution method 400 may commence at block 402 during which user data may be retrieved to obtain user data relevant to one or more sub-campaigns or line items and user actions associated with the one or more sub-campaigns and line items. In some embodiments, the user data may include one or more data values that describe or identify interactions between the user and one or more components of advertisement campaigns. Such user data may be stored in one or more servers of a distributed file system which may be configured to store the user data. In some embodiments, the one or more servers may be included in a Hadoop® distributed file system, as will be discussed in greater detail below with reference to FIG. 8 and FIG. 9. The user data may be identified and filtered based on a unique user identifier which may be associated with and identify a particular user, as well as an action identifier that is associated with and identifies a user action. Accordingly, an action identifier may include one or more data values that may be used by a system component, such as a control server, to identify the occurrence of a user action. In this way, action identifiers may be generated and stored to identify and track user actions. In various embodiments, user data, which may include sets of interactions, impressions, clicks, and user actions (as represented by action identifiers), may also be processed and filtered based on a timestamp associated with the data. For example, only data that was generated less than a predetermined period of time in the past may be retained for analysis. Similarly, only user actions that were generated within a predetermined period of time in the past may be retained for analysis.

In some embodiments, a first predetermined period of time may be defined that identifies a window of time in which a user action may have occurred. For example, data may be analyzed only for actions that occurred within the past ten days. In some embodiments, the time at which the first portion of the action attribution method 400 is executed may serve as a reference point for the first predetermined period of time. Moreover, a second predetermined period of time may be defined that identifies a window of time in which touch points or data points may have occurred. For example, data may be analyzed only for interactions that occurred up to seven days before each user action within the first predetermined period of time. It will be appreciated that such time constraints may be applied to any user data and any touch points or data points regardless of whether or not a user action actually resulted from the sequence including the data point. According to some embodiments, the second predetermined period of time may be implemented independently of the first predetermined period of time, and may use the time at which the first portion of the action attribution method 400 is executed as a reference point. Accordingly, for each user, impressions or interactions and clicks that occurred within a predetermined time period may be retained for analysis. Moreover, for each user, actions that occurred within a predetermined time period may be retained for analysis.

Once the user data has been retrieved and processed, the first portion of the action attribution method 400 may proceed to block 404 during which data objects including sequential representations of data points may be generated. Thus, according to some embodiments, the processed and filtered data may be arranged into one or more data objects which may be referred to as sequences. The sequences may include one or more data values which identify a series of data points that occurred for a particular user prior to the occurrence or non-occurrence of a user action. Thus, data points included in a sequence of events may be arranged and stored as a sequential representation of those data points. In some embodiments, the data values included in each sequence are filtered based on a user identifier, and are specific to a particular user's experience within an advertisement context. For example, a user may have purchased a product and, thus, completed a user action. Prior to the user action and within the predetermined period of time discussed above, the user may have viewed four advertisements from three different sub-campaigns, where each view would be identified and stored as a data point associated with the user based on a user identifier which may be retrieved from any suitable source, such as login information, mobile device information, or pattern recognition techniques. Accordingly, the sequence associated with the user action may include several data values that identify the user, the user action, and each of the four data points associated with the three sub-campaigns. The order of the data points within the sequential representation may be determined based on one or more characteristics or features associated with the data points, such as timestamp metadata. In various embodiments, sequences are generated and constructed as data objects for sequences of events that ended in no user action, as well as sequences of events that resulted in a user action.

Moreover, the generated data objects that include the extracted sequences may be processed to facilitate subsequent analysis. For example, sequences that ended in a user action, such as a purchase of a product or the filling out of a form, may be marked, flagged, or identified by a system component, such as a control server, as a sequence that resulted in a user action. This identification may be accomplished by the inclusion of a flag or identifier in the data object or generation of a mapping matrix stored elsewhere in the database system. Similarly, sequences that ended in no user action, such as no purchase being made, may be marked, flagged, or identified by a system component, such as a control server, as a sequence that did not result in a user action. Furthermore, for each sequence that leads to a user action, the control server may identify and record the identity of each line item associated with a data point included in the sequence. Moreover, for each sequence that did not lead to a user action, the control server may identify and record the identity of each line item associated with a data point included in the sequence. In this way, the control server may determine how many data points lead to a user action and did not lead to a user action for each line item.

The first portion of the action attribution method 400 may proceed to block 406 during which one or more data values included in the generated data objects may be de-duplicated. In some embodiments, multiple data points from the same sub-campaign/line item may be included in the same sequence or data object. For example, a user may have viewed an advertisement multiple times. Accordingly, the sequences may be processed to identify, based on a unique line item or sub-campaign identifier associated with each data point, duplicative data points. In some embodiments, such identifiers may be specific or unique to each data point. For example, one or more identifiers associated with an advertisement belonging to a sub-campaign may identify the campaign, the sub-campaign, as well as the advertisement itself. In various embodiments, any duplicative data points may be removed from the sequences that were generated during block 404.

The first portion of the action attribution method 400 may proceed to block 408 during which the probability of a line item being in a sequence that ends in a user action may be determined. According to some embodiments, such a probability may be represented as a probabilistic weight. In various embodiments, the probabilistic weight associated with a line item or sub-campaign may be determined by calculating the number of sequences that the line item or sub-campaign was in that resulted in a user action to generate a first number, calculating the total number of sequences that the line item or sub-campaign was in (regardless of whether such line item or sub-campaign resulted in a user action) to generate a second number, and then dividing the first number by the second number. As similarly discussed above with reference to block 404, such numbers may be generated by processing identifiers included in data points for each of the extracted sequences. In another example, after construction of the action and non-action sequences, the sequences may be stored in a database system as a data table and may be filtered or viewed based on an associated sub-campaign or line item identifier. Thus, for a particular line item, all relevant sequences that resulted in a user action may be available and readily identifiable, as well as all sequences that did not result in a user action. By viewing the number of entries in the data table, a system component, such as a control server, may readily determine how many sequences are included in each category for each line item or sub-campaign. Thus, the probabilistic weight for a particular line item may be determined by dividing the number of sequences resulting in a user action by the sum of the number of sequences resulting in a user action and the number of sequences not resulting in a user action. The probabilistic weight may be stored in the database system for later use.

The first portion of the action attribution method 400 may proceed to block 410 during which a cost associated with each sub-campaign or line item may be determined. Accordingly, the total amount spent by a particular line item or sub-campaign may be determined by summing a cost associated with each of all of the processed data points associated with the sub-campaign or line item. In some embodiments, the cost may be provided or defined as an advertiser defined data value. Accordingly, the relevant costs may be provided or determined by an advertiser associated with the line item or sub-campaign and may be stored in a database system. In various embodiments, a system component, such as a control server, may retrieve the stored costs for each data point included in the user data for each line item or sub-campaign. The control server may sum the identified and retrieved costs for each data point to generate a total cost for each line item or sub-campaign.

FIG. 5 illustrates a flow chart of an example of a second portion of an action attribution method, implemented in accordance with some embodiments. The second portion of the attribution allocation method 500 may attribute user actions to sub-campaigns or line items based, at least in part, on probabilistic weights associated with the sub-campaigns or line items. Thus, the second portion of the action attribution method 500 may determine a value returned by a sub-campaign or line item based on its attributed user actions, and may further determine one or more performance metrics, such as an overall return-on-investment (ROI) based on the returned value and cost associated with the sub-campaign or line item. Furthermore, according to various embodiments, the second portion of the action attribution method 500 may be performed in parallel with the first portion of the action attribution method 400. Thus, the first portion may be implemented and executed continuously and may continuously generate and update probabilistic weights such that the probabilistic weights represent the most current and relevant data. The second portion may access the probabilistic weights dynamically, thus enabling the second portion to access the most recently generated probabilistic weights which are most representative of the users' current behavior.

The second portion of the action attribution method 500 may commence at block 502 during which probabilistic weights associated with one or more sub-campaigns or line items may be retrieved. As previously discussed with reference to the first portion of the action attribution method 400, several probabilistic weights or probabilities may be determined that identify the probability of a line item or sub-campaign resulting in a user action. In various embodiments, the stored probabilistic weights may be retrieved by a system component, such as a control server, for analysis.

The second portion of the action attribution method 500 may proceed to block 503 during which the retrieved probabilistic weights may be normalized based on probabilistic weights associated with each user action. In some embodiments, before a user action may be assigned to line items or sub-campaigns, probabilistic weights or probabilities associated with the line items or sub-campaigns may be normalized to accurately and proportionally represent the fractional or partial contribution of each line item or sub-campaign to each user action. For example, if a line item includes a data point in a sequence of events leading to a user action, the retrieved weight associated with the line item may be normalized as part of the assignment or attribution process for that user action. Normalizing the probabilistic weights and probabilities in this way ensures that variances among line items or sub-campaigns which may result from, for example, different targeting criteria, do not affect the attribution process. Moreover, as discussed in greater detail below, such normalized probabilistic weights may be used to determine a value returned by a line item for a particular user action.

Accordingly, as discussed above with reference to block 502, a weight may be identified and retrieved for each line item or sub-campaign associated with each data point in a sequence of events leading up to a user action. In some embodiments, a total or sum of the probabilistic weights may be determined by summing all of the probabilistic weights that were retrieved for each sequence of events leading to each user action. The weight of each individual line item may be divided by the sum or total of all of the probabilistic weights for each user action to generate a normalized probabilistic weight for that user action. The resulting normalized probabilistic weight for each sub-campaign or line item may represent the portion of the user action that is attributed to that sub-campaign or line item.

For example, a sequence of events may lead to a user action, such as filling out a subscription form. The sequence of events may include a first data point associated with a first sub-campaign, a second data point associated with a second sub-campaign, and a third data point associated with a third sub-campaign. A first weight, a second weight, and a third weight may be retrieved for each respective sub-campaign, as determined by a previous iteration of method 400. The first, second, and third probabilistic weights may be summed to generate a total weight. Each of the first, second, third probabilistic weights may be divided by the total weight to generate a first normalized probabilistic weight, a second normalized probabilistic weight, and a third normalized probabilistic weight. Thus, the first normalized probabilistic weight, the second normalized probabilistic weight, and the third normalized probabilistic weight are specific to the user action that included the filling out of the subscription form, and the normalized probabilistic weights accurately represent which proportion of the filling out of the subscription form should be attributed to each of the first, second, and third sub-campaigns.

In various embodiments, the resulting normalized probabilities or probabilistic weights may be stored in a database system for further analysis, and may be used to determine a returned value for each line item or sub-campaign, as discussed in greater detail below with reference to block 505 and block 506.

The second portion of the action attribution method 500 may proceed to block 504 during which each user action may be assigned to at least one sub-campaign or line item. In various embodiments, a multi-touch attribution technique may be used to attribute the user action to the sub-campaigns or line items associated with it. For example, line items that include at least one data point in a sequence by, for example, showing at least one advertisement before a user action occurred may be attributed, at least in part, the user action based on a respective weight associated with the line item. As discussed above, the probabilistic weight may have been previously generated during the first portion of the action attribution method 400, and may have been normalized during block 503. Accordingly, the normalized probabilistic weights generated at block 503 may be used to determine a fraction of a user action that should be attributed to each sub-campaign or line item. The determined fractions may be associated with and stored with their respective sub-campaigns or line items at block 504.

As is apparent from the discussion above, the multi-touch attribution methods described herein may be highly accurate because they may proportionally attribute a user action to numerous sub-campaigns or line items, as may be appropriate in a user's context. For example, if a user performs an action, such as purchasing a product, the ultimate user action of the purchase may have been the result of the user seeing multiple advertisements over a period of time, and not just one. Moreover, the user may have found one advertisement more persuasive than another. Such relative contributions of the advertisements to the purchasing action are accurately represented by the above described multi-touch attribution method, and result in highly accurate calculations of values returned by sub-campaigns and line items, as well as ROIs for sub-campaigns and line items.

While various embodiments described herein utilize multi-touch attribution techniques, other attribution techniques may be used as well. For example, last-touch-attribution methodologies may be utilized as well. For example, the last or most recent data point, as may be determined by a time stamp or other metadata associated with the data point, may be attributed 100% of the user action, and the sub-campaign or line item associated with the data point may be attributed 100% of the user action.

The second portion of the action attribution method 500 may proceed to block 505 during which a value associated with each sub-campaign or line item may be determined for each user action. In some embodiments, each user action may have an associated value. The value may have been previously determined by an advertiser and may represent a monetary or economic value associated with the user action. The value of the user action may be multiplied by the normalized weight of a line item or sub-campaign that included a data point in the sequence of events leading to the user action. The result of multiplying the normalized weight with the value of the user action may be the proportional value of the user action that was returned by the line item or sub-campaign. For example, a value associated with a user action may be $15 corresponding to a purchase of a music album. Each data point included in the sequence of events leading to the purchase of the music album may be associated with a sub-campaign or line item. Accordingly, each of the associated sub-campaigns or line items may be attributed a fractional portion of the $15 dollars by multiplying the $15 with their respective normalized probabilistic weights. The result may identify a proportional or fractional value returned for each of the associated sub-campaigns or line items. Such a determination may be performed for each sub-campaign or line item associated with each user action included in the user data.

The second portion of the action attribution method 500 may proceed to block 506 during which a total value associated with each sub-campaign or line item may be determined. In various embodiments, the values determined at block 505 may be summed for each sub-campaign or line item to generate a value that represents the total value returned by that sub-campaign or line item across all user actions. In this way, a total value returned by each sub-campaign or line item may be determined based on their associated data points in the extracted sequences that resulted in user actions, and also based on values associated with those user actions.

The second portion of the action attribution method 500 may proceed to block 508 during which one or more performance metrics may be determined for each sub-campaign or line item. As previously discussed, a performance metric may be a metric that identifies or describes a spending efficiency of a sub-campaign or a line item. For example, a performance metric may be a return-on-investment (ROI) provided by the sub-campaign or line item. Accordingly, the total value returned which was determined during block 506 may be divided by the total cost that was determined during block 410 of the first portion of the action attribution method 400. The total value divided by the total cost determines the return-on-investment (ROI) for each sub-campaign and line item. The ROIs may be stored in a database system along with all of the other data. As previously discussed, the ROIs may be determined in parallel with the probabilistic weights and costs underlying the ROIs, thus allowing for increased throughput and processing capabilities.

In some embodiments, a system component, such as a control server, may be configured to generate an image or user interface screen capable of displaying one or more data values on a display device of a computer system. According to various embodiments, the user interface screen may include one or more data fields including information generated by method 400 and method 500. For example, control server may be configured to generate a user interface screen that includes a first data field identifying a total number of user actions attributed to each line item or sub-campaign. The user interface screen may also include a second data field identifying a total value returned by each line item or sub-campaign. The user interface screen may further include a third data field identifying an ROI for each line item or sub-campaign. Accordingly, one or more results or data values determined by method 400 and method 500 may be rendered as components of a graphical user interface and presented to a user at a display device of a computer system.

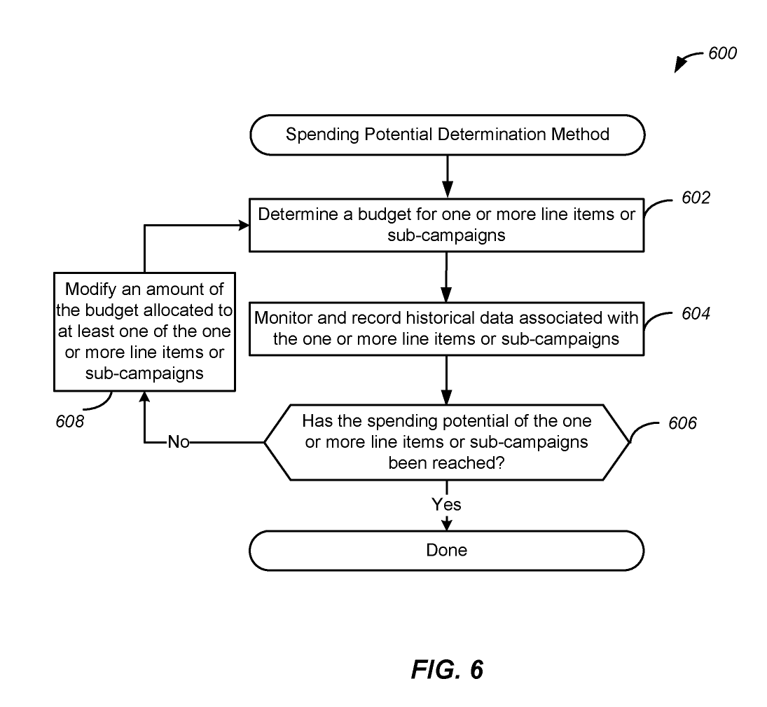

FIG. 6 illustrates a flow chart of an example for determining a spending potential, implemented in accordance with some implementations. As previously discussed, optimal allocation of a budget may utilize knowledge of a spending potential associated with each sub-campaign/line item associated with the budget. In some embodiments, sub-campaigns or line items may apply different targeting criteria to show different advertisements to different groups of potential buyers of a product. Furthermore, there might not be the same number of users in each of the different groups. Thus, the potential for an impression opportunity and a consequent advertising budget spending potential may vary among different sub-campaigns and line items due, among other things, to the varying targeting criteria. Accordingly, the spending potential of a sub-campaign or line item should be considered when allocating the budget across sub-campaigns. For example, a large amount of money should not usually be allocated to a specific sub-campaign that cannot reach enough users to be able to spend the money even if such sub-campaign has a high return on investment. In some embodiments, the amount of money a sub-campaign may spend may depend on both the number of users reached, as well as the bid price for an advertisement. For example, if a sub-campaign bids low, it will not be able to win an auction for an advertisement, will not receive impression opportunities, and will not spend any of its budget. Accordingly, the spending potential determination method 600 may be implemented to provide accurate determinations of spending potentials of sub-campaigns and line items, thus enabling the accurate and efficient allocation of the overall budget for a campaign amongst different sub-campaigns or line items.

The spending potential determination method 600 may commence at block 602 during which a budget may be determined for each of one or more line items or sub-campaigns. According to various embodiments, an adaptive budget assignment methodology may be implemented to determine the spending potential of each line item or sub-campaign. Accordingly, at block 602, a system component, such as a control server, may allocate to each sub-campaign or line item an initial budget that may be spent by each sub-campaign or line item over a period of time which may be, for example, a single day. According to various embodiments, the amount of the budget assigned may be determined based on historical performance data associated with a sub-campaign or line item. In some embodiments, there might not be any historical performance data associated with at least one of the sub-campaigns or line items. In these embodiments, an initial amount of the budget may be determined based on a default value. For example, if no previous iterations of the spending potential determination method 600 have been performed, then there is no historical data for any of the sub-campaigns or line items included in the advertisement campaign. In this example, all sub-campaigns or line items in the campaign may initially be allocated a default value equivalent to equal shares of the campaign's overall budget.

The spending potential determination method 600 may proceed to block 604 during which the progress and spending behavior of each sub-campaign or line item may be tracked, monitored, and logged. Accordingly a system component, such as a control server, may periodically ping or query one or more processes, system components, or servers used to implement the sub-campaigns or line items. The control server may record one or more data values describing spending behavior associated with each sub-campaign or line item. For example, the control server may monitor and record how much of the budget was allocated, how much was spent, and how much was left over at the end of the budget cycle.

The spending potential determination method 600 may proceed to block 606 during which it may be determined whether or not the spending potentials of the one or more line items or sub-campaigns have been reached. In various embodiments, such a determination may be made based on the historical data monitored and logged during block 604. For example, if the data that was logged for a sub-campaign at the end of the day indicates that the sub-campaign did not spend all of its money and had a large amount left (for example, greater than a threshold value of 20%), it may be determined that the spending potential for that sub-campaign has not been reached. Moreover, if it is determined that the remaining budget at the end of the day is small (less than a threshold value of 5%) or has been spent entirely, it may also be determined that the spending potential for that sub-campaign has not been reached. Accordingly, such a determination may be made based on spending behavior of each of the one or more line items or sub-campaigns as illustrated or shown by the historical data that has been logged during one or more iterations of the spending potential determination method 600.

In some embodiments, if it is determined that the spending potential of the one or more line items or sub-campaigns has been reached, then method 600 may terminate. According to various embodiments, such a determination may be made if one or more criteria or conditions are fulfilled. For example, the spending potential of a sub-campaign may be identified and may have been determined to have been reached when the budget allocated to that sub-campaign does not change by a significant amount for a predetermined number of budget cycles. For example, if the budget allocated to a sub-campaign or line item does not change by more than 5% for at least three budget cycles, a system component such as a control server may determine that the spending potential of the sub-campaign has been reached. In some embodiments, such criteria or conditions, such as threshold values and numbers of budgets of cycles, may have been previously determined or configured by an advertiser. Accordingly, upon successive iterations of the spending potential determination method 600, the allocated budget for each of the one or more line items or sub-campaigns may ultimately stabilize at a value that may be identified as a spending potential for each particular line item or sub-campaign. Once the spending potential of the one or more line items or sub-campaigns has been reached and identified, the spending potential determination method 600 may terminate.

However, if it is determined that the spending potential of the one or more line items or sub-campaigns has not been reached, the spending potential determination method 600 may proceed to block 608 during which an amount of a budget allocated to at least one of the one or more line items or sub-campaigns may be modified. Returning to previous examples, if it was determined that a sub-campaign or line item did not spend all of its money and had a large amount left, the amount of the budget allocated to the sub-campaign the next day may be reduced. Moreover, if it is determined that the remaining budget at the end of the day is small or has been spent entirely, the amount of the budget allocated to the sub-campaign the next day may be increased. Accordingly, during block 608, the budget for a sub-campaign or line item may be modified dynamically based on the historical data that was recorded, at least in part, at block 604. In this way, the budget allocated towards sub-campaigns may be modified dynamically and in response to the sub-campaigns performance in the previous budget cycle.

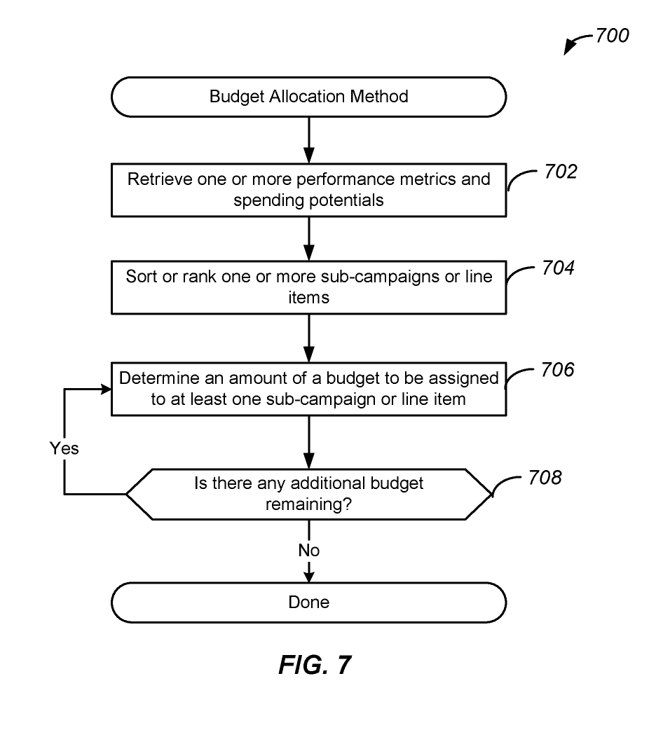

In some embodiments, the amount that the budget allocated towards a sub-campaign or line item is incremented or decremented may be a predetermined amount. For example, a default value may be used, such as an increase or decrease of 5%, 10%, or 20%. Moreover, the amount increased or decreased may be configured based on a performance metric, such as an ROI, associated with each of the sub-campaigns. For example, if a first sub-campaign and a second sub-campaign both qualify for an increase in a budget, the first sub-campaign may be given a larger increase in budget if it has a greater ROI (or an ROI that is a certain percentage greater) than the second sub-campaign. Thus, according to some embodiments, the adaptive budget assignment methods may assign as much of the budget as possible to the sub-campaigns that perform better (e.g., have a high return-on-investment). As discussed in greater detail below with reference to FIG. 7, the sub-campaigns/line items may be ordered or ranked according to their respective ROIs. In this example, the adaptive budget assignment methods may identify the sub-campaigns with the highest ROIs based on their rank, and assign as much of the budget as possible to the higher ranking line items. Once the budget has been modified, the spending potential determination method 600 may return to block 602, and another budget cycle may be implemented.

FIG. 7 illustrates a flow chart of an example of a method that may be used to allocate a budget, implemented in accordance with some embodiments. As similarly discussed above, the determination of spending potentials, action attributions, and performance metrics may facilitate the allocation of an overall budget associated with a campaign. In various embodiments, the budget allocation method 700 may use previously determined performance metrics and spending potentials to allocate a budget for a campaign to one or more line items or sub-campaigns included in the campaign.

Accordingly, the budget allocation method 700 may commence at block 702 during which one or more determined performance metrics and spending potentials may be retrieved. As previously discussed with reference to FIG. 4, FIG. 5, and FIG. 6, performance metrics and spending potentials may be calculated or determined for each sub-campaign or line item, and may be stored in a database system. Accordingly, during block 702, the performance metrics and spending potentials may be retrieved from one or more servers of the database system for each line item or sub-campaign associated with or included in the campaign for which a budget is being allocated.

The budget allocation method may proceed to block 704 during which one or more sub-campaigns or line items may be sorted or ranked. In various embodiments, the one or more sub-campaigns or line items may be sorted or ranked based on the performance metrics that were retrieved at block 702. For example, the campaign for which the budget is being allocated may include several sub-campaigns. Each of the sub-campaigns may have an associated ROI value that was previously determined. The ROI values may be retrieved and the several sub-campaigns may be sorted or ranked based on their respective retrieved ROI values. In one example, the sub-campaign having the highest ROI may be ranked highest and may be assigned the highest position in a data structure representing a ranked list of the several sub-campaigns. Accordingly, all line items or sub-campaigns included in a campaign may be sorted and ranked in descending order based on their respective ROIs. In this way a data structure may be generated that includes one or more data values identifying a sorted list in which line items or sub-campaigns having the highest ROIs are assigned the highest ranks.

The budget allocation method 700 may proceed to block 706 during which an amount of a budget to be assigned to at least one sub-campaign or line item may be determined. Accordingly, during block 706, an amount may be deducted from the overall budget for a campaign and assigned or allocated to a sub-campaign or line item included in the campaign. Thus, during block 706 one or more allocated budgets may be determined for sub-campaigns or line items, and may be assigned to the sub-campaigns or line items. It will be appreciated that the determined allocated budgets are each portions or fractions of the overall budget available to the campaign that includes the sub-campaigns or line items. In some embodiments, the sub-campaign or line item may be identified based on its performance metric or rank. For example, the budget may be assigned to the sub-campaign or line item having the highest ROI value and corresponding rank as determined in accordance with block 704. In various embodiments, the determined spending potential of each line item may be utilized to determine how much of the budget to allocate. Accordingly, the sub-campaign or line item identified during block 706 may be assigned an amount of the budget that is equal to its spending potential. If the remaining budget is less than the sub-campaign or line item's spending potential, the remaining budget may be assigned instead. As will be discussed in greater detail below with reference to block 708, any remaining budget associated with the campaign may be assigned to other sub-campaigns or line items in an iterative fashion, and in descending order of ROI value.

Accordingly, the budget allocation method 700 may proceed to block 708 during which it may be determined whether or not any budget remains. If it is determined that no budget remains and all of the budget for the campaign has been allocated, the budget allocation method 700 may terminate. However, if it is determined that some budget remains, the budget allocation method 700 may return to block 706. For example, if the remaining budget is greater than zero, the budget allocation method 700 may return to block 706 to assign the remaining budget to other additional sub-campaigns or line items. For example, a line item with the highest ROI may be ranked at the top of the list based on its ROI, and may be the first to be allocated a budget, as discussed above with reference to block 706. If there is any remaining budget, the budget allocation process 700 may be repeated for the next highest ranked line item or sub-campaign. Accordingly, the second highest ranked sub-campaign or line item may be assigned an amount of the budget, which may be equal to its spending potential. This may be repeated for all ranked sub-campaigns or line items. In this way, the budget allocation process 700 may be repeated until there is no remaining budget, or there are no more line items or sub-campaigns included in the list that have not been assigned a budget up to their spending potential. Accordingly, an overall budget for a campaign may be distributed among its sub-campaigns/line items based on determined spending potentials and ROIs associated with each of the sub-campaigns/line items.

FIG. 8 illustrates an example of a data processing system which may be used to implement a first portion of an action attribution method in accordance which some embodiments. As previously discussed, portions of an attribution method may be easily parallelized. In some embodiments, a parallel implementation may enable the processing of data associated with a large number of users, which may be about in the order of billions. Given that the data for each user may include both action and no-action sequences, the total amount of profile data may be in the order of tens of terabytes. In some embodiments, the action attribution method may be executed daily for each advertiser, and may be scheduled by Oozie® Workflow Scheduler. In some embodiments the execution or implementation of the action attribution methods may be configured based on one or more parameters, characteristics, or attributes associated with the advertiser or users associated with the advertiser. For example, the action attribution methods may be configured to execute at a particular time, which may be the close of business hours, as determined by the advertiser's time zone.

In some embodiments, the action attribution methods may take about in the order of tens of seconds per mapper, such as mapper 802, for each of the first portion and second portion of the action attribution methods when implemented with billions of users and multiple advertisers. The overall method may utilize in the order of tens of thousands of mappers, and each iteration of the method may be performed daily. In some embodiments the methods may be implemented on Hadoop® and may utilize a Hadoop® distributed file system (HDFS) 804. As previously discussed, FIG. 8 illustrates an implementation of the first portion of the action attribution methods, which may be used to determine probabilistic weights for each sub-campaign or line item.

As similarly discussed above, the first portion and second portion of the action attribution methods may be implemented in parallel. Such a parallel implementation may include partitioning the whole set of users into many mappers, which may be used to extract the action and no-action sequences from the user data. For each sequence, a line item or sub-campaign identifier may be extracted as a key. Additional information or data values that may be extracted include: (i) cost for the data points of the line item or sub-campaign inside the sequence, (ii) whether the sequence is an action sequence (as may be indicated by a data value of 1), and (iii) whether this sequence is a no-action sequence (as may be indicated by a data value of 0). The data values may be sent to several reducers, such as reducer 806. In some embodiments, data values having the same key may be sent to the same reducer, thus enabling aggregation. Each reducer may generate a line item identifier, and an aggregated total number of action and no-action sequences associated with each line item which may be used to determine a weight, as may be performed during the second portion of the action attribution methods.

FIG. 9 illustrates an example of a data processing system which may be used to implement a second portion of an action attribution method in accordance with some embodiments. As previously discussed, a second portion of the action attribution methods may be used to determine actual action attribution as well as a line item or sub-campaign level return-on-investment (ROI). As similarly discussed above with reference to FIG. 8, user data may be partitioned into various mappers, such as mapper 902. However, during the second portion, each mapper may process only sequences which resulted in a user action. Furthermore, the output of the first portion, which may include line item or sub-campaign probabilistic weights or probabilities as well as total costs, may be provided to the mappers since these values may be used to determine an action attribution and ROI for each line item or sub-campaign. The output of the first portion may be provided by one or more servers 908 configured to implement the action attribution methods described above with reference to FIG. 4 and FIG. 5 which may include, at least in part the system described above with reference to FIG. 8. For each user action sequence, the mappers may generate a line item or sub-campaign identifier as a key for each line item that had a touch-point inside the action sequence being analyzed. Moreover, the mappers may also generate the following values: (i) total cost of a line item or sub-campaign (in some embodiments, this may have been previously generated by the first portion), (ii) percentage of the user action that is attributed to a line item or sub-campaign, and (iii) the value of the user action×attributed action value, which represents the money generated by advertising under this line item or sub-campaign. As discussed above with reference to FIG. 8, the same keys may be collected within the same reducer, such as the reducer 906, and the reducer may aggregate the values to determine the total user action value received by a line item or sub-campaign, as well as the ROI for the line item or sub-campaign.

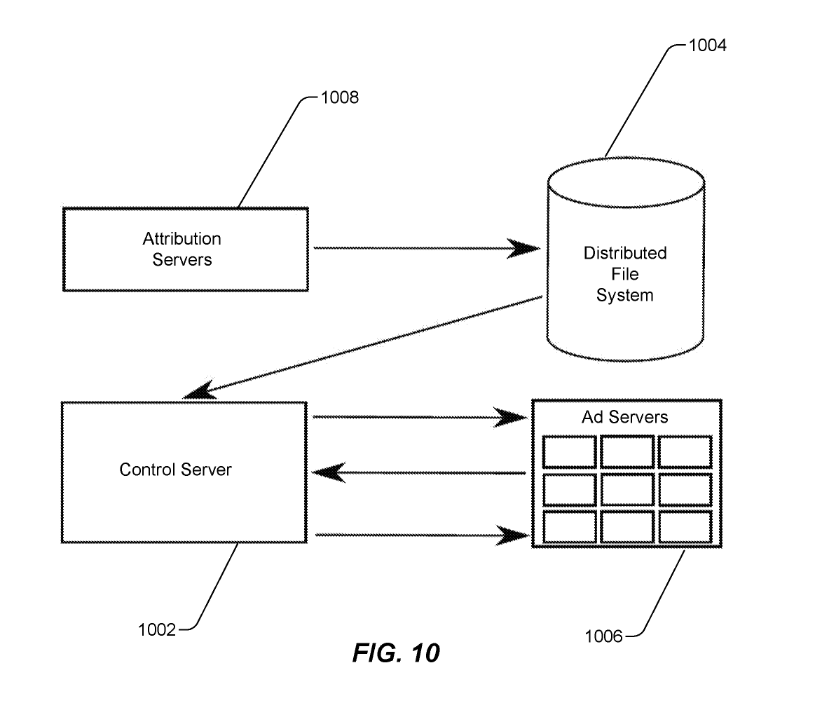

FIG. 10 illustrates an example of a data processing architecture that may be used to allocate a budget, implemented in accordance with some embodiments. In various embodiments, the budget allocation methods described above may be implemented and executed on a control server, such as the control server 1002, which may be communicatively coupled with and may retrieve attribution information, such as multi-touch attribution performance information generated by the methods described above with reference to FIG. 4 and FIG. 5, from a Hadoop Distributed File System (HDFS) 1004, which may be populated by an Oozie® job implemented on one or more servers 1008 configured to implement the action attribution methods described above with reference to FIG. 4 and FIG. 5. The control server 1002 may subsequently determine and allocate budgets for line items or sub-campaigns, as described above with reference to FIG. 6 and FIG. 7, and may determine the spending rates and capabilities for various time periods within a budget cycle, which may be a business day. These spending rates and capabilities may be sent to advertisement servers 1006 which may be configured to send messages to other servers, where the messages include bid requests for advertisements. In this way, the advertisement servers 1006 may spend money on advertisements in accordance with the spending rates and allocated budgets. The money spent for each line item may be returned from the advertisement servers 1006 to the control server 1002. The control server 1002 may be configured to send the advertisement servers 1006 a signal that starts or stops line items or sub-campaigns from further spending if the line items or sub-campaigns have depleted their budgets for the day.

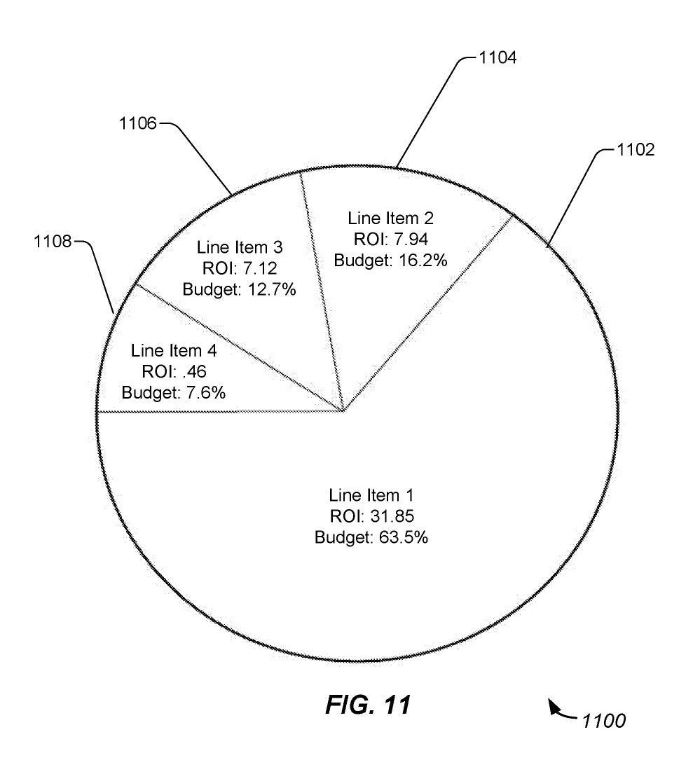

FIG. 11 illustrates a graph of an example of multi-touch attribution-based allocation of a budget, implemented in accordance with some embodiments. As shown in graph 1100, the budget associated with a campaign has been distributed among line items or sub-campaigns in a highly accurate fashion. In this example, a campaign includes various line items, such as line item 1 (LI1) 1102, line item 2 (LI2) 1104, line item 3 (LI3) 1106, and line item 4 (LI4) 1108. The line item with the lowest ROI, which is LI4 1108, has been allocated the smallest percentage of the overall budget. As represented in graph 1100, LI4 1108 has an ROI of 0.46 and has only been allocated 7.6% of the overall budget. Furthermore, LI1 1102 has the highest ROI (an ROI of 31.85) and has been allocated the largest percentage of the budget (63.5% of the overall budget). Further still, the line item with the next smallest ROI (LI2 1104) was assigned the next smallest percentage of the budget. As represented in graph 1100, LI2 1104 has an ROI of 7.94 and has been assigned 16.2% of the overall budget. Moreover, the line item with the next smallest ROI (LI3 1106) was assigned the next smallest percentage of the budget. As represented in graph 1100, LI3 1106 has an ROI of 7.12 and has been assigned 12.7% of the overall budget. Accordingly, the difference in the amount of budget allocated to each line item or sub-campaign is commensurate with the relative difference in their ROIs. Thus, the multi-touch attribution-based budget allocation method has effectively and efficiently allocated the overall budget of the campaign among sub-campaigns or line items to maximize the return on the money spent by the campaign.

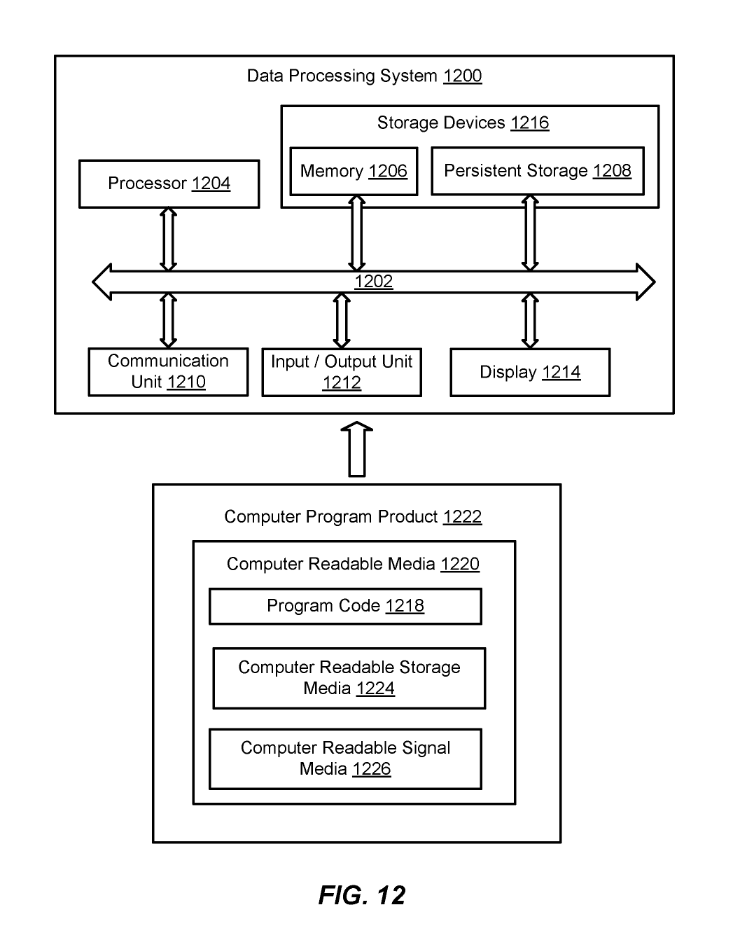

FIG. 12 illustrates a data processing system configured in accordance with some embodiments. Data processing system 1200, also referred to herein as a computer system, may be used to implement one or more computers used in a controller or other components of systems described above. In some embodiments, data processing system 1200 includes communications framework 1202, which provides communications between processor unit 1204, memory 1206, persistent storage 1208, communications unit 1210, input/output (I/O) unit 1212, and display 1214. In this example, communications framework 1202 may take the form of a bus system.

Processor unit 1204 serves to execute instructions for software that may be loaded into memory 1206. Processor unit 1204 may be a number of processors, a multi-processor core, or some other type of processor, depending on the particular implementation.

Memory 1206 and persistent storage 1208 are examples of storage devices 1216. A storage device is any piece of hardware that is capable of storing information, such as, for example, without limitation, data, program code in functional form, and/or other suitable information either on a temporary basis and/or a permanent basis. Storage devices 1216 may also be referred to as computer readable storage devices in these illustrative examples. Memory 1206, in these examples, may be, for example, a random access memory or any other suitable volatile or non-volatile storage device. Persistent storage 1208 may take various forms, depending on the particular implementation. For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that may be connected to data processing system 1200. For example, input/output unit 1212 may provide a connection for user input through a keyboard, a mouse, and/or some other suitable input device. Further, input/output unit 1212 may send output to a printer. Display 1214 provides a mechanism to display information to a user.

Instructions for the operating system, applications, and/or programs may be located in storage devices 1216, which are in communication with processor unit 1204 through communications framework 1202. The processes of the different embodiments may be performed by processor unit 1204 using computer-implemented instructions, which may be located in a memory, such as memory 1206.

These instructions are referred to as program code, computer usable program code, or computer readable program code that may be read and executed by a processor in processor unit 1204. The program code in the different embodiments may be embodied on different physical or computer readable storage media, such as memory 1206 or persistent storage 1208.

Program code 1218 is located in a functional form on computer readable media 1220 that is selectively removable and may be loaded onto or transferred to data processing system 1200 for execution by processor unit 1204. Program code 1218 and computer readable media 1220 form computer program product 1222 in these illustrative examples. In one example, computer readable media 1220 may be computer readable storage media 1224 or computer readable signal media 1226.

In these illustrative examples, computer readable storage media 1224 is a physical or tangible storage device used to store program code 1218 rather than a medium that propagates or transmits program code 1218.

Alternatively, program code 1218 may be transferred to data processing system 1200 using computer readable signal media 1226. Computer readable signal media 1226 may be, for example, a propagated data signal containing program code 1218. For example, computer readable signal media 1226 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 1200 are not meant to provide architectural limitations to the manner in which different embodiments may be implemented. The different illustrative embodiments may be implemented in a data processing system including components in addition to and/or in place of those illustrated for data processing system 1200. Other components shown in FIG. 12 can be varied from the illustrative examples shown. The different embodiments may be implemented using any hardware device or system capable of running program code 1218.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a plurality of mappers configured to extract a plurality of sequences from user data, wherein each of the plurality of sequences includes a sequential representation of data events associated with a user and a sub-campaign of a plurality of sub-campaigns, and wherein at least some of the plurality of sequences identify a sequence of data events having at least one action identifier of a plurality of action identifiers corresponding to at least one of a plurality of user actions;
a plurality of reducers configured to generate, for each sub-campaign, a first set of aggregated numbers identifying sequences including action identifiers, and further configured to generate, for each sub-campaign, a second set of aggregated numbers of sequences not including action identifiers;
a plurality of servers configured to generate a plurality of probabilistic weights based on the generated plurality of sequences, the first set of aggregated numbers, and the second set of aggregated numbers, and wherein the plurality of servers is further configured to generate a plurality of performance metrics based on the plurality of probabilistic weights; and
a distributed file system configured to store the user data, the plurality of sequences, the plurality of probabilistic weights, and the plurality of performance metrics.

2. The system of claim 1, wherein the user data is partitioned and assigned to each of the plurality of mappers based on a plurality of user identifiers.

3. The system of claim 1, wherein the plurality of mappers is further configured to extract a plurality of costs associated with data events included in the plurality of sequences.

4. The system of claim 1, wherein the plurality of mappers is further configured to determine a percentage of at least one user action of the plurality of user actions that is attributed to at least one sub-campaign of the plurality of sub-campaigns.

5. The system of claim 1, wherein each probabilistic weight of the plurality of probabilistic weights identifies a probability of a sub-campaign being associated with an action identifier of the plurality of action identifiers.

6. The system of claim 5, wherein the plurality of probabilistic weights is normalized.

7. The system of claim 1, wherein the plurality of reducers is configured to generate the first and second aggregated numbers based on a plurality of sub-campaign identifiers associated with the plurality of sequences.

8. The system of claim 1, wherein the determining of the plurality of performance metrics further comprises:
determining a value associated with each sub-campaign of the plurality of sub-campaigns;
determining a total cost associated with each sub-campaign of the plurality of sub-campaigns; and
determining a return-on-investment associated with each sub-campaign of the plurality of sub-campaigns based on the determined value and the determined total cost associated with each sub-campaign.

9. The system of claim 8, wherein the plurality of servers are further configured to determine a plurality of allocated budgets based on the plurality of performance metrics, each allocated budget of the plurality of allocated budgets being determined for each sub-campaign of the plurality of sub-campaigns, and each allocated budget of the plurality of allocated budgets being a portion of a total budget associated with an advertisement campaign.

10. The system of claim 9, wherein the plurality of servers are further configured to send a message to additional servers based on at least one of the plurality of allocated budgets, the message including a bid request for an advertisement.

11. The system claim 1, wherein the distributed file system is a Hadoop distributed file system.

12. A system comprising:
a distributed file system;
one or more processors configured to:
extract a plurality of sequences from user data, wherein each of the plurality of sequences includes a sequential representation of data events associated with a user and a sub-campaign of a plurality of sub-campaigns, and wherein at least some of the plurality of sequences identify a sequence of data events having at least one action identifier of a plurality of action identifiers corresponding to at least one of a plurality of user actions;
generate, for each sub-campaign, a first set of aggregated numbers identifying sequences including action identifiers;
generate, for each sub-campaign, a second set of aggregated numbers of sequences not including action identifiers; and
a plurality of servers configured to generate a plurality of probabilistic weights based on the generated plurality of sequences, the first set of aggregated numbers, and the second set of aggregated numbers, and wherein the plurality of servers is further configured to generate a plurality of performance metrics based on the plurality of probabilistic weights.

13. The system of claim 12, wherein the user data is partitioned and assigned to each of a plurality of mappers based on a plurality of user identifiers.

14. The system of claim 13, wherein the one or more processors are further configured to:
extract a plurality of costs associated with data events included in the plurality of sequences;
determine a percentage of at least one user action of the plurality of user actions that is attributed to at least one sub-campaign of the plurality of sub-campaigns; and
generate the first and second aggregated numbers based on a plurality of sub-campaign identifiers associated with the plurality of sequences.

15. The system of claim 12, wherein each probabilistic weight of the plurality of probabilistic weights identifies a probability of a sub-campaign being associated with an action identifier of the plurality of action identifiers.

16. The system of claim 12, wherein the distributed file system is a Hadoop distributed file system.

17. A method comprising:
extracting, using a plurality of mappers, a plurality of sequences from user data, wherein each of the plurality of sequences includes a sequential representation of data events associated with a user and a sub-campaign of a plurality of sub-campaigns, and wherein at least some of the plurality of sequences identify a sequence of data events having at least one action identifier of a plurality of action identifiers corresponding to at least one of a plurality of user actions;
generating, using a plurality of reducers, a first set of aggregated numbers identifying sequences including action identifiers;
generating, using the plurality of reducers, a second set of aggregated numbers of sequences not including action identifiers;
generating, using one or more processors, a plurality of probabilistic weights based on the generated plurality of sequences, the first set of aggregated numbers, and the second set of aggregated numbers; and
generating, using the one or more processors, a plurality of performance metrics based on the plurality of probabilistic weights.

18. The method of claim 17, wherein the user data is partitioned and assigned to each of the plurality of mappers based on a plurality of user identifiers.

19. The method of claim 17, wherein the method further comprises:
extracting, using the plurality of mappers, a plurality of costs associated with data events included in the plurality of sequences;
determining, using the plurality of mappers, a percentage of at least one user action of the plurality of user actions that is attributed to at least one sub-campaign of the plurality of sub-campaigns; and
generating, using the plurality of reducers, the first and second aggregated numbers based on a plurality of sub-campaign identifiers associated with the plurality of sequences.

20. The method of claim 17, wherein each probabilistic weight of the plurality of probabilistic weights identities a probability of a sub-campaign being associated with an action identifier of the plurality of action identifiers.
